(19) United States
(12) Patent Application Publication
(10) Pub. No.: US 2005/0267848 A1
(43) Pub. Date: Dec. 1, 2005

(54) Methods and systems for applying additional postage to mail items

(75) Inventor: Dennis L. Kenbeek, Broken Arrow, OK (US)

Correspondence Address: PERKINS, SMITH & COHEN LLP, ONE BEACON STREET, 30TH FLOOR, BOSTON, MA, 02108, US

(73) Assignee: Lockheed Martin Corporation, Besthesda, MD (US)

(21) Appl. No.: 10/853,634

(22) Filed: May 25, 2004

(51) Int. Cl. G06F 17/60

(52) U.S. Cl. 705/406

(57) ABSTRACT

Methods and systems for automatically applying additional postage to mail items within presorted mail. The method of this invention for acting upon presorted mail, in order to adjust postage applied to the presorted mail, includes the step of determining the correctness of the postage applied to individual items within the presorted mail. If the postage applied is incorrect, the method of this invention also includes the following steps, performed while the individual items are being transported through a mailing apparatus: a) weighing separately the individual items in order to determine the weight of each individual item; b) determining an additional amount of postage to be applied to the individual items, in order to correct the postage for the individual items; and, c) applying the additional amount of postage to the individual items. Systems that implement the method of this invention are also disclosed.

### BACKGROUND OF THE INVENTION

This invention relates generally to methods and systems for applying additional postage to mail items, and, more particularly, to methods and systems for applying additional postage to mail items within presorted mail.

Many postal systems offer customer discounts for performing presort prior to providing the mail to the postal system. In the presort environment, mail piece discounts are provided for varying levels of presort, e.g., 5-digit postal code or more detailed postal destination definition. In a mailing qualifying for discounts (automation, etc.), postage must be affixed to each mail piece at the lowest rate claimed in the mailing.

Historically, mail pieces not qualifying for a discounted rate in a mailing, i.e., reject pieces, have gone through a post-presort process to add additional postage to each piece so that the piece can be mailed at the Single Piece rate. Under some mailing rates, the additional postage (the upcharge), is identical for pieces of different weights, e.g., one (1) ounce and 2 ounce. Under some recent mailing rates, the upcharge is different for different weights of the mail piece, requiring the separation of mail pieces of different weights in addition to the process of applying additional postage.

For mailing rates in which the additional postage (the upcharge) is identical for different weights of the mail piece, additional postage can be applied using a postage meter affixed to a mailing machine with an automatic feeder. The upcharge, i.e., additional postage, is keyed in to the postage meter by an operator and mail pieces are fed through the mailing machine allowing the postage meter to apply the additional postage. As the upcharge is identical for mail pieces of different weights, no separation of mail pieces by weight is required.

For mailing rates in which the additional postage (the upcharge) is different for different weights of the mail piece, manual sorting by weight of the mail pieces not qualifying for a discounted rate in a mailing (reject pieces) is typically utilized. The mail pieces can be weighed and sorted by weight when it is determined that the mail pieces do not qualify for a discounted rate. Alternatively, after determining that the mail pieces do not qualify for a discounted rate, the mail pieces are weighed and sorted by weight.

There is a need for methods and systems for automatically applying additional postage to mail items within presorted mail.

### BRIEF SUMMARY OF THE INVENTION

Methods and systems for automatically applying additional postage to mail items within presorted mail are disclosed.

The method of this invention for acting upon presorted mail, in order to adjust postage applied to the presorted mail, includes the step of determining the correctness of the postage applied to individual items within the presorted mail. If the postage applied is incorrect (incorrect postage being postage that is less the required postage), the method of this invention also includes the following steps:
a) weighing separately the individual items, while the individual items are being transported through a mailing apparatus, in order to determine the weight of each individual item;
b) determining, while the individual items are transported through the mailing apparatus, an additional amount of postage to be applied to the individual items, in order to correct the postage for the individual items; and,
c) applying, while the individual items are transported through the mailing apparatus, the additional amount of postage to the individual items.

The method of this invention can also include the step of obtaining an actual amount of the postage applied to individual items within the presorted mail. The actual amount of the postage applied to individual items within the presorted mail can, in one embodiment, be obtained by obtaining an image of each individual item within the presorted mail and processing the image of each individual item in order to obtain the actual amount of the postage applied to each individual item.

Systems that implement the method of this invention are also disclosed.

### BRIEF DESCRIPTION OF THE SEVERAL VIEWS OF THE DRAWING

FIG. 1 is a flowchart representation of an embodiment of the method of this invention; and

FIG. 2 is a block diagram representation of an embodiment of the system of this invention.

### DETAILED DESCRIPTION OF THE INVENTION

Methods and system for automatically applying additional postage to mail items within presorted mail are disclosed herein below.

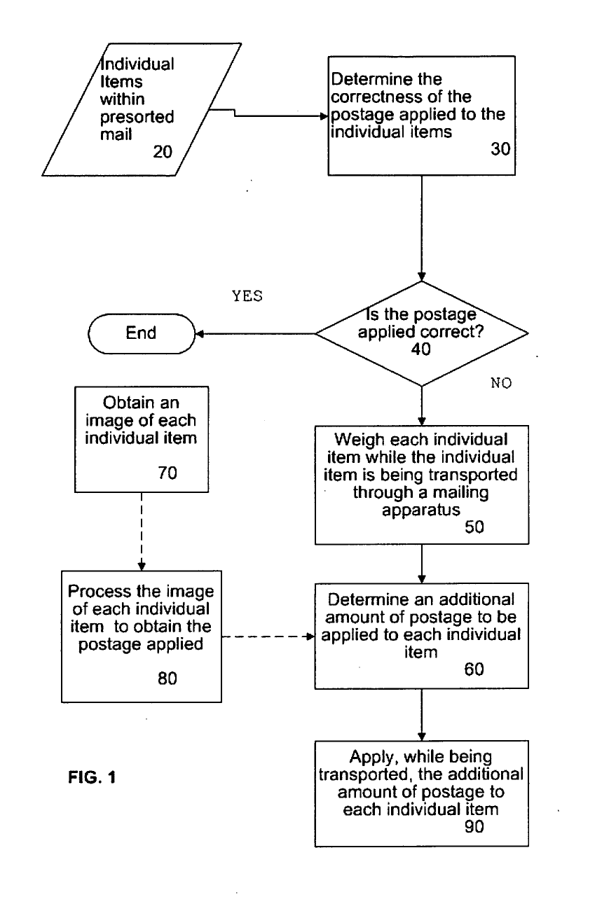

A flowchart of an embodiment of the method 10 of this invention is shown in FIG. 1. Referring to FIG. 1, at the start of the method 10, the correctness of the postage applied to individual items within the presorted mail 20 is determined (step 30, FIG. 1). If the postage applied is correct (step 40, FIG. 1), the individual items within the presorted mail 20 are mailed and the method ends. (As used herein correct postage is postage equal to or more than the required postage.) If the postage applied is incorrect (step 40, FIG. 1), the method includes the following steps. If the postage applied is incorrect, the individual items are weighed separately, while being transported through a mailing apparatus, in order to determine the weight of each individual item (step 50, FIG. 1). After weighing each individual item separately, an additional amount of postage to be applied to the individual items is determined, while the individual items are transported through the mailing apparatus, in order to correct the postage for the individual items (step 60, FIG. 1). If additional postage is needed, the additional amount of postage is applied to the individual items while the individual items are transported through the mailing apparatus (step 90, FIG. 1).

In one embodiment, the method 10 can include obtaining an actual amount (a value) of the postage applied to individual items within the presorted mail (not shown). The actual amount of the postage applied to individual items within the presorted mail could be, in one specific embodiment, be obtained as an input when the correctness of the postage applied to individual items within the presorted mail 20 is determined (step 30, FIG. 1). In another specific embodiment, an image of at least a portion of each individual item within the presorted mail is obtained (step 70, FIG. 1) and the image is processed in order to obtain the actual amount of the postage applied to each individual item (step 80, FIG. 1).

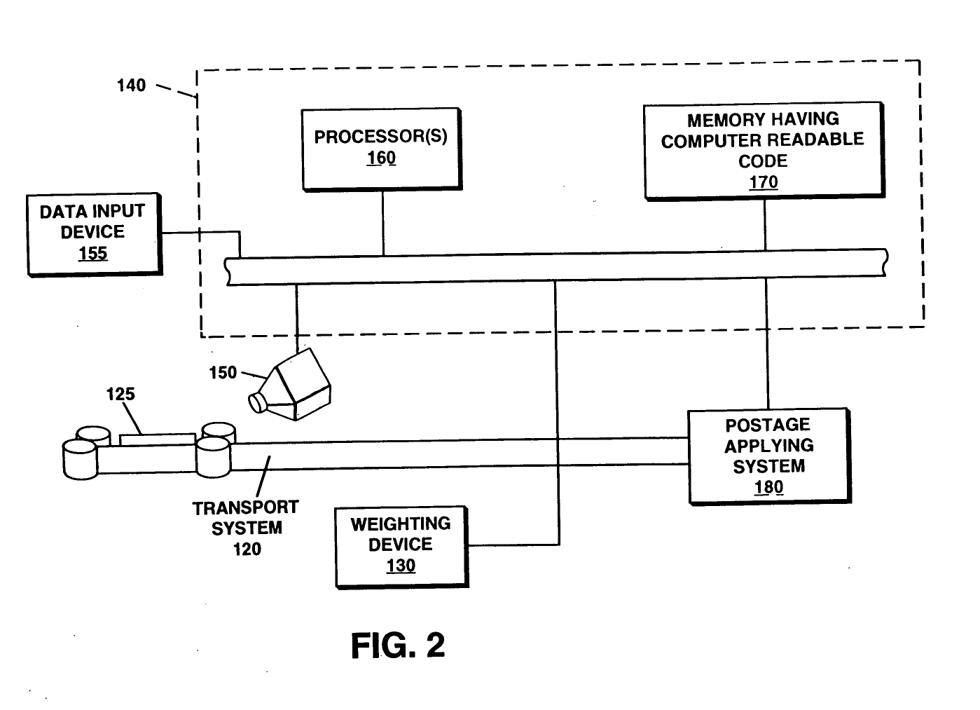

A block diagram representation of an embodiment 100 of the system of this invention is shown in FIG. 2. Referring to FIG. 2, Referring to FIG. 2, the system 100 includes a transport sub-system 120 capable of transporting individual mail items, an input sub-system 110 capable of providing individual items within the presorted mail to the transport system, if the postage applied to individual items is incorrect, and a weighing sub-system 130 capable of weighing each individual item being transported by the transport system. In one embodiment, but not limited to, the transport sub-system 120 and the input sub-system 110 comprise conventional components utilized in conveyor systems transporting mail. The weighing sub-system 130 can, in one embodiment but not limited to, be the weighing sub-system described in U.S. Pat. No. 4,788,018 or U.S. Pat. No. 4,497,386, both of which are incorporated by reference herein. Referring again to FIG. 2, the system 100 includes one or more processors 160 and one or more computer readable memories 170 having computer readable code embodied therein, the computer readable code capable of causing the one or more processors 160 to calculate a required postage for each individual item from a weight for each individual item being transported by the transport system and an actual amount of the postage applied to individual items within the presorted mail, if the postage applied to individual items in the pre-sorted mail is incorrect. The actual amount of the postage applied to individual items within the presorted mail can, in one embodiment but not limited to, be an obtained through the data input device 155 or through other means including means detailed below. The embodiment 100 of the system of this invention shown in FIG. 2 also includes a postage applying sub-system 180 capable of applying the additional amount of postage to the individual items being transported by the transport system. In one embodiment, the postage applying sub-system 180 can be a postage meter accepting digital input.

Another embodiment of the means for obtaining an actual amount (a value) of the postage applied to individual items within the presorted mail is also shown in FIG. 2. Referring again to FIG. 2, the system 100 of this invention also includes an image acquisition sub-system 150 capable of obtaining an image of at least a portion of each individual item within the presorted mail. The one or more computer readable memories 170 also have computer readable code embodied therein, the computer readable code capable of causing the one or more one processors 160 to process the image and obtain the actual amount of the postage applied to each individual item from the processed image of each individual item. The image acquisition sub-system 150 can, in one embodiment but not limited to, be a digital camera, a video camera or a sub-system including an imaging device such as a CCD or CMOS sensor. The computer readable code capable of causing the one or more one processors 160 to process the image of each individual item can, in one embodiment but not limited to, include block recognition software, optical character recognition software and image recognition software.

In another embodiment (not shown) of the system of this invention, a mail sorter is modified to include a weighing sub-system capable of weighing each individual item being transported by the transport system, while being transported, and one or more computer readable memories having computer readable code embodied therein, the computer readable code being capable of causing one or more processors to calculate a required postage for each individual item based on the weight of each individual item. The additional amount of postage to be applied to each of the individual items can be calculated from a comparison of the required postage and the postage previously applied to each of the individual items within the presorted mail. The transport sub-system of the mail sorter is capable of transporting the individual mail items. The computer at the mail sorter provides the one or more processors, the one or more computer readable memories, and can be modified to include the computer readable code. The actual amount of the postage applied to individual items within the presorted mail can, in this embodiment, be entered as input to the computer or be read by a bar-code reader. The postage applying sub-system can be incorporated into the sorter or postage can be applied as an indicator.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. Input device, as used herein, refers to any device, such as, but not limited to, a keyboard, a mouse, voice input, a touch sensitive pad or display, a computer pen, or a writing tablet, that is used to provide input data to provide data to programmable computer. The output information may be applied to one or more output devices.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

1. A method for adjusting postage previously applied to presorted mail, the method comprising the steps of:
determining correctness of the postage previously applied to individual items within the presorted mail;
transporting the individual items through a mailing apparatus;
if the previously applied postage is incorrect,
(a) weighing separately, while the individual items are transported through the mailing apparatus, the individual items in order to determine the weight of each individual item;
(b) determining, while the individual items are being transported through the mailing apparatus, an additional amount of postage to be applied to each of the individual items, in order to correct the postage for each of the individual items; and,
(c) applying, while the individual items are being transported through the mailing apparatus, the additional amount of postage to each of the individual items.

2. The method of claim 1 further comprising the step of:
obtaining a value for the postage previously applied to each of the individual items.

3. The method of claim 2 wherein the step of obtaining the value for the postage previously applied to the individual items comprises the steps of:
obtaining an image of at least a portion of each of the individual items within the presorted mail;
processing the image in order to obtain the value for the postage previously applied to each of the individual items.

4. A system for adjusting postage previously applied to the presorted mail, the system comprising:
a transport sub-system capable of transporting individual mail items of the presorted mail;
an input sub-system capable of providing the individual items to the transport sub-system;
a weighing sub-system capable of weighing each of the individual items being transported by the transport sub-system,
means for determining an additional amount of postage to be applied to each of the individual items being transported by the transport sub-system;
a postage applying sub-system capable of selectively applying the additional amount of postage to each of the individual items being transported by the transport system.

5. The system of claim 4 further comprising:
means for obtaining a value of postage applied to individual items within the presorted mail.

6. The system of claim 5 wherein the means for obtaining the value of the postage applied to individual items comprise:
an image acquisition sub-system capable of obtaining at an image of at least a portion of each of the individual items within the presorted mail;
at least one processor; and,
at least one computer readable memory having computer readable code embodied therein, the computer readable code capable of causing the at least one processor to:
process the image, and,
obtain a value of the postage applied to each of the individual items from the processed image of each of the individual items.

7. The system of claim 4 wherein the means for determining an additional amount of postage to be applied to each of the individual items comprise:
at least one processor; and,
at least one computer readable memory having computer readable code embodied therein, the computer readable code capable of causing the at least one processor to:
calculate a required postage for each of the individual items based on weight, and,
determine the additional amount of postage to be applied to each of the individual items based on a comparison of required postage and the postage previously applied to each of the individual items within the presorted mail.
